(19) United States
(12) Patent Application Publication
(10) Pub. No.: US 2012/0041603 A1
(43) Pub. Date: Feb. 16, 2012

(54) SYSTEM FOR THE CENTRAL CONTROL OF OPERATIONAL DEVICES

(76) Inventor: Jörg Wilmsen, Essen (DE)

(21) Appl. No.: 13/203,111

(22) PCT Filed: Feb. 26, 2010
(86) PCT No.: PCT/EP10/52466

§ 371 Date: Nov. 7, 2011

(30) Foreign Application Priority Data
Feb. 27, 2009 (DE) 10 2009 001 224.9

(51) Int. Cl. G05D 23/19

(52) U.S. Cl. 700/277

(57) ABSTRACT

The present invention describes a system for the central control of operational devices, and in particular an improved system for the central control of operational devices in a plurality of spaces or buildings which uses energy, for example heating energy, cooling energy or light energy, more efficiently. The system comprises at least two operational device controllers for controlling at least two operational devices and is designed to receive a control signal; at least two sensors for detecting the operational state in at least two spaces; at least one control unit in a building which is designed to receive an operational state-detection signal and for transmitting a control signal; and a central control unit which is communicatively connected to the at least one control unit for transmitting and receiving signals, wherein the control unit generates the control signal on the basis of operational state setpoint value information in a signal from the central control unit.

### TECHNICAL DOMAIN

The present invention relates to a system for the central control of operational devices, and in particular a system for the central control of heating devices, cooling devices, lighting devices, etc. in a plurality of spaces or buildings, which can be controlled remotely from a central control unit.

### PRIOR ART

A number of different control/regulating systems for operational devices are known. For example, in the simplest case heating appliances are equipped with a device for roughly controlling the temperature, such as a valve which when opened introduces hot water into the heating appliance, Furthermore, heating systems are known which make it possible for a temperature to be pre-specified for a space, the temperature of the space then being regulated to this value by the system.

With such heating systems the overall heat of the house is generally not taken into account because users control the temperature of their apartments individually or possibly also do not control it in their absence. One often acts here upon the assumption of a subjective heat sensitivity, and therefore considerable temperature fluctuations vary greatly depending on the day, the time and the apartment.

However, fluctuating temperatures in buildings are not energy-efficient, i.e. by changing the temperature in a building more uniformly or by keeping it constant energy could be saved. Furthermore, with considerable temperature fluctuations, undercooling of an apartment, possibly with frost damage, can also occur, and this could easily be avoided.

Moreover, heating bills for individual apartments are generally not produced dependently upon the prevailing temperature in the apartment, but upon the basis of units of heat consumed which are usually read more or less correctly directly from heating appliances, and this gives rise to high costs. Since the units of heat measured are greatly dependent upon the characteristics of a user, e.g. an apartment tenant and the position of the heat unit counter as well as the environment in which it is located, the consumption of units of heat does not correlate to the temperature sensitivity of the user.

In the case of lighting installations this type of control is not known at all. Timer switches and similar devices can be used here, but monitoring of such devices with sensors is not provided. This can easily lead to there being good room illumination when the sun is shining, but the inhabitant forgetting to switch the lights off. In business and office areas this problem is even greater because often the employees do not feel responsible for the energy costs and do not turn off the lights when they leave their place of work.

### SUMMARY OF THE INVENTION

It is therefore desirable to provide an improved system for controlling operational devices which resolves at least some of the aforementioned problems and leads to better energy efficiency.

A solution to this object is provided by the system for the central control of operational devices having the features of Claim 1.

This system comprises at least two operational device controllers for controlling at least two operational devices which can be located in the same or also in different buildings. Each of the operational device controllers is designed to receive a control signal. The system further comprises at least two sensors for detecting the operational state of the at least two operational devices, each of the sensors being designed to transmit an operational state detection signal. The system additionally comprises at least one control unit in a building which is designed to receive an operational state detection signal and to transmit a control signal to at least one of the operational device controllers, and a central control unit which is communicatively connected to the at least one control unit for transmitting signals to the control unit and for receiving signals from the control unit, the control unit generating the control signal on the basis of operational state setpoint value information in a signal from the central control unit.

Therefore, a control signal is pre-specified in order to always regulate an operational state of an operational device to an operational state setpoint value. Thus, inefficient, large operational state changes which can result from interventions by the user can be avoided, and more efficient use of energy can be achieved by central control of, for example, the apartment and building temperature.

Preferably, the operational state setpoint value information constitutes at least one operational state setpoint value specified by the central control unit for at least one operational device. Therefore the central control unit can adapt the operational state in one or more operational devices individually to different or the same operational state.

Furthermore, a further control unit in another building is advantageously provided which is communicatively connected to the central control unit in order to transmit and receive signals. Therefore a respective control unit for a building can communicate with the central control unit, e.g. by wireless communication means or wired broadband systems so that it is even made possible to control buildings in different towns. Here the control unit is preferably connected to at least one operational state device controller and at least one sensor, and the further control unit is connected communicatively to at least one other operational state device controller and at least one other sensor.

The signal communication between the at least one control unit and the central control unit is preferably implemented by means of mobile radio communication, i.e. mobile radio transmission technology such as GSM, GPRS or UMTS. Therefore, the position of the central control unit can be selected freely, with no fixed communication lines to the control unit having to be installed in the building either, and therefore the position of the control unit in the building is not dependent either upon the presence of data lines to the outside.

The central control unit is preferably designed to receive instructions for specifying and changing operational state setpoint value information via the internet or mobile radio from a terminal. Therefore, the central control unit can, in turn, be controlled from an external, portable terminal, for example, such as a laptop computer or a mobile telephone.

Preferably, the at least one control unit is connected wirelessly to the at least two operational device controllers and the at least two sensors for communicating. Therefore, the position of the control unit in the building is also independent of internal building lines, and this greatly facilitates modification of an existing system and/or installation of a new system.

Furthermore, every operational device controller preferably has identification so that a control signal with corresponding identification can be assigned to an operational device controller. Individual communication with different operational device controllers is thus simplified, and fine-tuning of the operational state, for example in different spaces, is made possible.

Furthermore, the control unit is preferably designed to communicate with another device so that, for example, a main power supply in the building is controlled.

In a further embodiment a method for the central control of operational devices, particularly for a plurality of buildings, is described. The method comprises the steps of receiving a signal transmitted from a central control unit with operational state setpoint value information with a control unit in a building, and receiving an operational state detection signal from at least one sensor which is representative of the operational state, such as a temperature, in a space. The method further comprises the steps of generating in the control unit a control signal on the basis of the signal transmitted by the central control unit and the operational state detection signal and transmitting the control signal to an operational device controller for controlling at least one operational device in the space. Therefore, the operational state in a space can be specified from a central point so that strong fluctuations in the operational state due to individual changing of the operational state by a user can be avoided.

### BRIEF DESCRIPTION OF THE DRAWINGS

FIG. 1 shows diagrammatically a system for the control of operational devices by means of a central control unit in a building according to a specific embodiment of the invention.

FIG. 2 shows diagrammatically a system for the central control of heating devices by means of a central control unit for a plurality of buildings according to a further specific embodiment of the invention.

FIG. 3 shows a flow chart which demonstrates the steps of a method for the central control of heating devices according to a further specific embodiment of the invention.

### DETAILED DESCRIPTION OF PREFERRED EMBODIMENTS

In the following, preferred embodiments of the present invention are described in detail with reference to the accompanying drawings. Here, in different drawings, the same or corresponding components are respectively identified with the same or similar reference numbers.

The preferred embodiments of the invention, which are described in detail below, are described in detail with reference to a system for the control of heating devices in rooms of buildings. It is noted, however, that the heating device can also be understood to be an air-conditioning system, i.e. for heating and for cooling. It is further noted that the heating device is only described representatively of other operational devices. A heating device can also be understood to be an air-conditioning system for heating and for cooling because the concept of an increase in temperature can also be applied immediately to a reduction in temperature. Different operational devices can be any type of electrical appliance, such as a lighting system or lighting installation or a refrigerator. It is therefore noted that the following description only includes examples, and should not be considered as restricting the invention. Furthermore, the spaces in buildings can also be different areas of factories or apartments in one- or multiple-family houses, or also administration buildings.

All of the specific embodiments described below have in common that the temperature, i.e. temperature setpoint value information, specified by the central control unit is essentially independent of the user. This means, for example, that a fixed temperature setpoint value is specified for a space, and is regulated by the control unit by communicating with the controller or heating device controller and the temperature probe or temperature sensor in the space. For example, in this way a landlord can ensure that frost damage due to undercooling of the apartment or the space does not occur. Moreover, it is possible to monitor the temperature in the apartment with the central control unit by requesting the temperature by means of the control unit with the temperature sensor.

Therefore, a temperature in the space or apartment can be kept constant in accordance with the agreement between the tenant and the landlord, and a landlord would for example only have to pay for the contractually agreed temperature, and not for greatly varying and meaningless units of heat, the annual reading of which gives rise to further unnecessary costs for the tenant and the landlord.

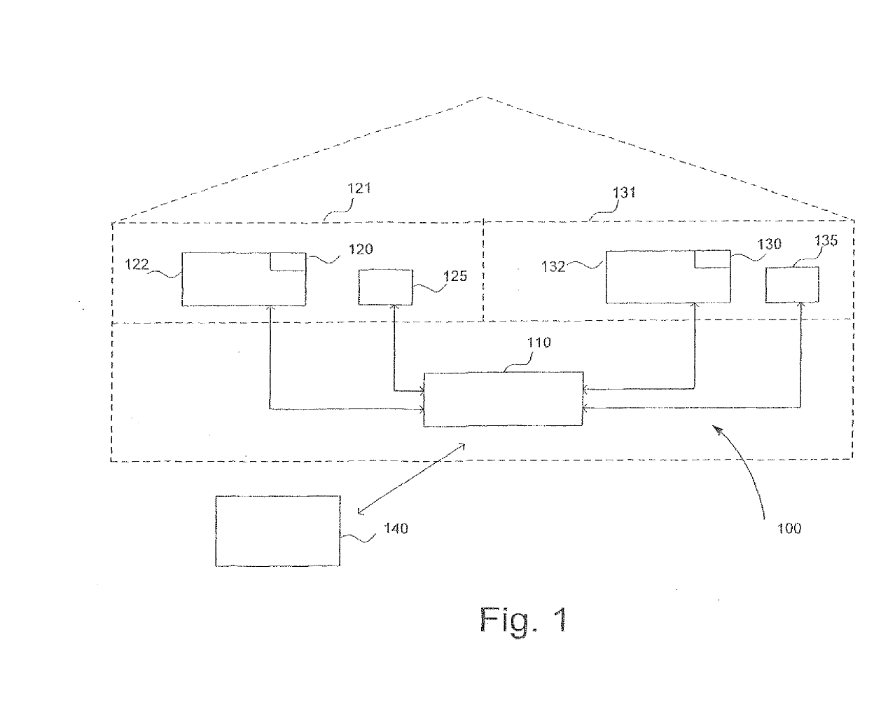

FIG. 1 shows an example of a system according to the invention for the central control of operational devices in a building. The system 100 comprises a control unit 110, an operational device control 120, which is described as a heating device controller, and which controls an operational device 122, e.g. a heating device in the space 121, as well as a sensor 125, which here is in the form of a temperature sensor. The system further comprises a second operational device controller 130, which is described as a heating device controller, for controlling a second operational device 132, e.g. a heating device, and a second sensor 135, which is described as a temperature sensor in the space 131.

The control unit 110 is designed to receive an operational state detection signal, in this example a temperature detection signal, and to transmit a control signal to at least one of the operational device controllers.

In addition, the system comprises a central control unit 140, which is communicatively connected to the control unit 110 for transmitting and receiving signals to or from the control unit 110, the control unit 110 generating the control signal on the basis of operational state setpoint value information which, in the example of FIG. 1, corresponds to temperature setpoint value information in a signal from the central control unit.

For example, a temperature profile of the inhabitant of the space 121 is stored in a memory of the central control unit. This temperature profile shows, for example, that the inhabitant desires a temperature of 22° C. during the day, and a temperature of 18° C. at night. The central control unit that is communicatively connected to the control unit 110 now transmits a signal that includes, for example, the temperature setpoint value, such as. 22° C., to the control unit 110. Furthermore, the control unit 110 receives from the temperature sensor 125 a temperature detection signal that specifies the current temperature in the space 121. This temperature detection signal can be transmitted to the control unit 110 at certain intervals of time, e.g. every minute, or it is also possible for the control unit 110 to issue a request for the temperature to the temperature sensor 125, which then transmits the temperature detection signal to the control unit 110.

On the basis of the temperature setpoint value information, i.e. of the signal with the specified temperature setpoint value, such as 22° C., and of the temperature detection signal, the control unit 110 generates a control signal for controlling the heating device controller 120. The heating device controller 120 can thus be controlled and regulated until the specified temperature, for example 22° C., is achieved in the space 121.

It is also possible for the control signal to only specify to the heating device controller 120 that a certain temperature is to be achieved in the space, e.g. by transmitting the temperature setpoint value information to the heating device controller. Here, the heating device controller 120 controls the heating device 122 until the desired temperature prevails in the space by the heating device controller 120 communicating with the temperature sensor 125 in order to learn whether the corresponding temperature value has been adopted in the space 121. In this modification of the example, it is therefore not necessary for the control signal to be generated on the basis of a temperature detection signal because the information of the temperature detection signal is processed by the heating device controller. However, it is desirable for the control unit 110 to receive a temperature detection signal which reproduces the current temperature of the space so that this information can also be relayed, e.g. to the central control unit which can be accessed in order to display the temperature profile of the space.

As described above, the heating device controller 120 is designed to control at least one heating device 122, and is designed to receive a control signal. For example, the heating device controller 120, after receiving the control signal, regulates a valve or pump for the heating device so that a desired temperature value is obtained.

The heating device controller can be a conventional heating device controller which communicates wirelessly or connected by wire to a control unit and/or a temperature sensor. Commercially available heating device controllers for such purposes are produced, for example, by Honeywell, Siemens, Danfoss, etc.

According to the structure of the system, different commercially available temperature sensors, such as those produced by Honeywell, Siemens, Thermokon, etc., can also be used. A temperature sensor is designed to detect the temperature in at least one space, and is also designed to transmit a temperature detection signal.

In particular, it is not necessary for the temperature sensor and the heating device controller to be in the same space of the same company because the control unit 110 preferably communicates individually with the temperature sensor 125 and the heating device controller 120 respectively so that the control unit 110 is able to receive, understand and process different communication protocols from different component suppliers. This leads to increased flexibility in the system structure and reduces the retrofitting or maintenance costs since one can fall back on existing maintenance contracts or existing components, such as temperature sensors and heating device controllers.

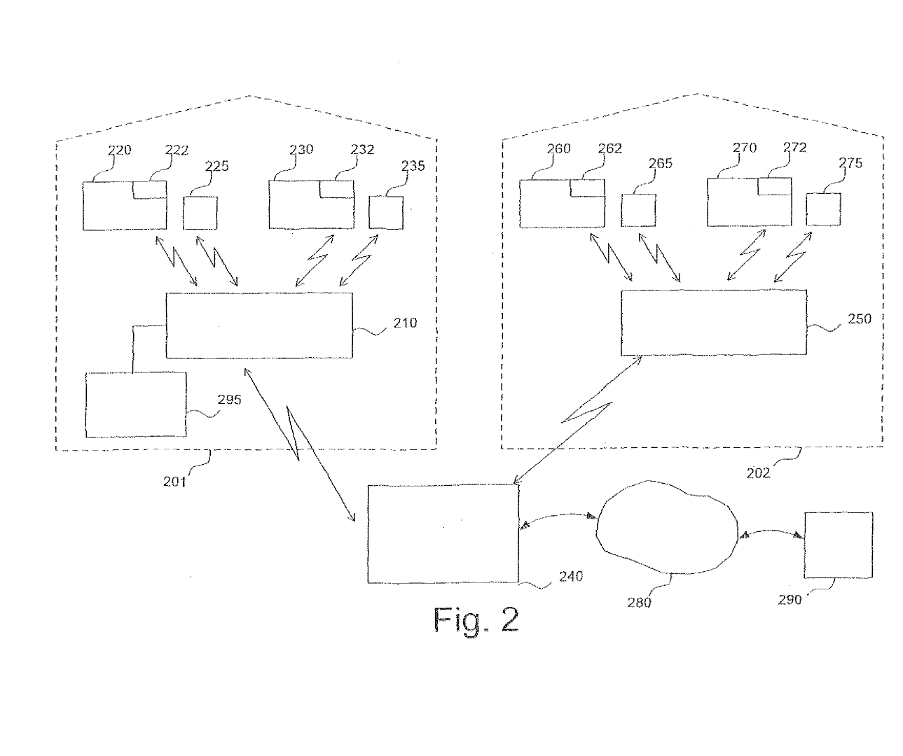

The control unit is able, for example, to be connected to one or to a number of bus systems known in building automation, such as KNX or EnOcean, and to communicate with components made by a number of manufacturers. This communication can also take place wirelessly, as shown diagrammatically in FIG. 2.

The heating device 122 to be controlled is not restricted to a heating appliance, but can also be an underfloor heating system, a radiant heater, or other types of heating device.

Similarly to what was explained above with reference to the space 121, the temperature in the space 131 can also be controlled correspondingly. The space 131 does not have to be located in the same apartment as the space 121, and it is even conceivable for the space 131 to be located in a different building, as described in greater detail with reference to FIG. 2.

As above with the space 121, temperature setpoint value information, which includes at least one temperature setpoint value specified by the central control unit for the space 131, is transmitted to the control unit 110. It is also possible for the temperature setpoint value information to include two or more temperature setpoint values, for example for the space 121 and the space 131, which are then processed in the control unit 110 with regard to a temperature detection signal from the spaces.

The heating device 132, the heating device controller 130 and the temperature sensor 135 are located in the space 131. The temperature sensor 135 detects the temperature of the space and communicates this to the control unit 110 as a temperature detection signal. The control unit 110 generates on the basis of the temperature detection signal of the temperature sensor 135 and the aforementioned temperature setpoint value information a control signal which is transmitted to the heating device controller 130 in the space 131 in order to control a temperature in the space.

The possibility of the heating device controller 120 or 130 being controlled physically or manually by the inhabitant of the space is not desirable here because in this way a temperature profile pre-specified by the central control unit is changed, and considerable temperature fluctuations or energy inefficiency can occur again as usual if, for example, the inhabitant forgets to reduce the temperatures at night. A temperature essentially independent of the user can thus be achieved.

It is noted that a specified temperature does not have to be totally independent of the user/inhabitant because provision can be made such that the inhabitant discusses a temperature profile with the operator of the central control unit or the landlord of the apartment in which he/she lives, and the temperature profile can then be pre-installed.

FIG. 2 shows diagrammatically a second example of the system for the central control of heating devices.

In particular, FIG. 2 shows two different control units 210 and 250 in two buildings 201 and 202. The arrangement of the components in the building 201 corresponds substantially to the arrangement described in FIG. 1, but the components in this example preferably communicate wirelessly. Furthermore, the control unit 210 is connected to a heating system 295. As in FIG. 1, the heating device controllers 222 and 232 communicate with the control unit 210, the control unit 210 being able to receive temperature detection signals from the temperature sensors 225 and 235. The heating device controllers 222 and 232 in turn control the heating device 220 and the heating device 230.

It is noted that in hot water heating systems, for example, the heating device controller controls a valve of the heating appliance in order to introduce hot water into the heating appliance, such as the heating device 220. However, it may be that the temperature of the hot water to be introduced is not high enough to achieve the temperature setpoint value pre-specified for the space. It may therefore be necessary for the control unit 210 to increase the temperature of the hot water flowing to the heating device 220 by means of corresponding instructions to the heating system 295 which is connected by lines (not shown) to the heating devices 220 and 230.

The wireless connection between the control unit 210 and the temperature sensors 225 and 235 and the heating device controllers 222 and 232 can be realised, for example, by means of a wireless connection to KNX, EnOcean, etc. Components made by different manufacturers can also be used here because the control unit 210 is designed to receive, understand and process different protocols.

The arrangement of the components in the building 202 is similar in structure to the arrangement of the components in the building 201. In the example described with reference to FIG. 2, a second control unit 250 is provided which is communicatively connected to the central control unit 240 for transmitting and receiving signals. In this example, therefore, two different control units 210 and 250 are communicatively connected to the central control unit 240, this connection preferably being formed wirelessly, as will be further specified below.

The control unit 250 and also the control unit 210 can receive from the central control unit 240 temperature setpoint value information with regard to one or a number of temperature setpoint values for a space. In addition, the control unit 250 is designed, for example, to receive temperature detection signals from temperature sensors in the building 202, i.e. from the temperature sensors 265 and 275. The control unit 250 thus receives by means of the temperature detection signal information about the current temperature in the space or the spaces in which the sensors are located, and calculates on the basis of this information and the temperature setpoint value information from the central control unit 240 one or a number of control signals which are transmitted to the heating device controllers 262 and 272 which in turn control the heating devices 260 and 270.

In order to enable smooth communication between the control unit and heating device controllers, each heating device controller has identification, such as an identification number, so that a control signal with corresponding identical identification can be assigned to the correct heating device controller. A similar identification scheme is also provided for communication between the central control unit 240 and the control units 210 and 250, in particular when a connection is established between the latter wirelessly.

The signal communication between the control unit 210 and the central control unit 240 or the control unit 250 and the central control unit 240 preferably takes place by means of mobile radio communication such as GSM, GPRS or UMTS. Therefore the identification of the control unit can take place simply by means of a telephone number. Furthermore, by means of a mobile radio connection the position of the central control unit 240 is not bound spatially and can be positioned hundreds of kilometers away from the spaces/buildings to be controlled. Likewise, the buildings can also be located in different towns or even different countries.

By means of the flexible connection to the central control unit 240, heating devices can be controlled centrally in buildings a long way away from one another, and this enables not only central temperature control, but also central monitoring of different temperatures in different spaces in different buildings. For example, it is conceivable for an inhabitant to request his/her temperature profile from the central control unit 240 in order to plan a change to his/her temperature profile. This change can then be negotiated with the apartment landlord or the operator of the central control unit.

In particular, the control unit 210 or 250 contains a GSM communication module in order to communicate with another GSM communication module or with a landline. The other GSM communication module or landline can, but does not have to be integrated into the central control unit 240, but it is also conceivable for the other GSM communication module or landline to only relay the communication between the control unit 210 and the central control unit 240, for example by means of line-switched or packet-switched, e.g. internet, communication. Therefore, mobile radio costs can be minimised, especially when the central control unit is located abroad.

As already stated above, positioning of the control unit 210 or control unit 250 is easier the more wireless communication is used because the position is not dependent upon existing electrical wiring or other lines or ductwork located in the wall of the building.

Installation and retrofitting is thus simplified. For example, this type of control unit can be disposed in the cellar of a building or at a different location where the technology for the premises is located.

In the above example, a wireless short distance network is preferably used between the components of the space and the control unit, in which distances of approx. 100 m are bridged, it being possible to overcome much greater distances by mobile radio communication with the central control unit.

The central control unit 240 is, for example, a high performance server with one or more microprocessors and data storage. For example, the data storage serves to record the temperature profile in different spaces in different buildings, and this can be implemented, for example, by the temperature detection signal, the temperature information of which can be relayed from the control unit in the building to the central control unit 240 and be recorded.

The temperature prevailing in a space can thus be recorded centrally over time, and be compared to a pre-specified temperature profile that is theoretically to be realised in the spaces by the temperature setpoint value information. A request for the recorded data and an examination of a temperature profile or change or addition to a temperature profile can take place, for example, by means of a terminal 290.

The terminal 290 is e.g. a mobile telephone or a laptop computer and can be communicatively connected by a mobile radio network or the internet 280 to the central control unit 240. Therefore, instructions for specifying and changing setpoint value information are obtained independently of the location of the terminal 290 from the central control unit 240. Therefore, essentially user-independent temperature control is realised with which a constant basic temperature for a space or a building can easily be specified, and with which considerable individual temperature fluctuations in spaces should be avoided, which leads to a higher degree of energy efficiency.

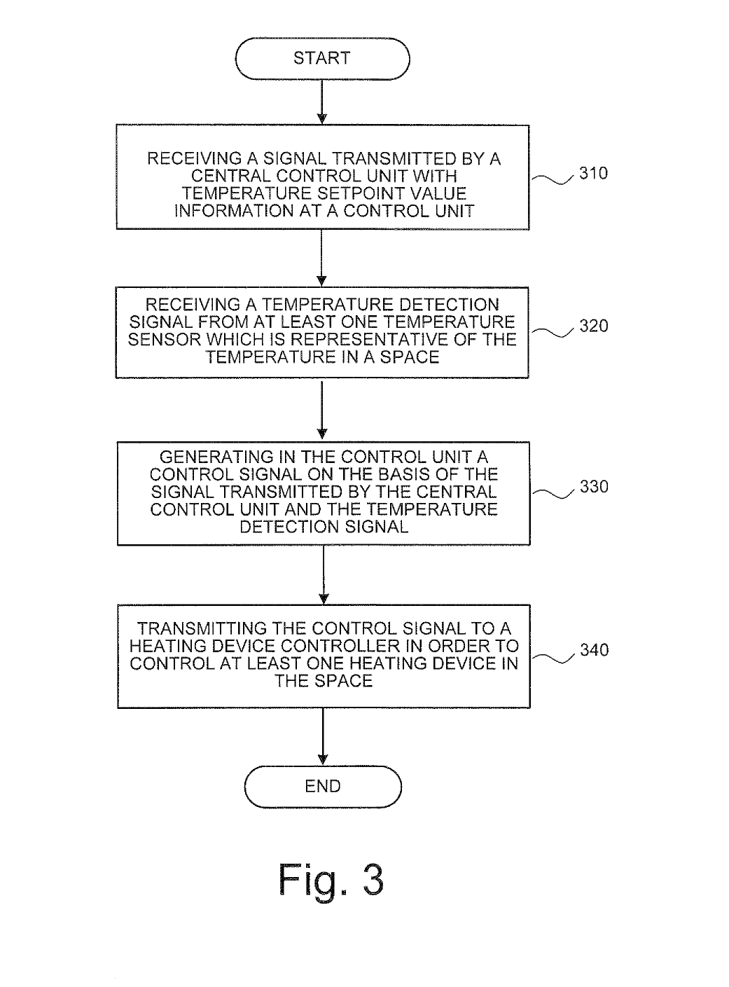

In the following, a method is now described with the aid of the flow chart with reference to FIG. 3 which has steps for the central control of heating devices, in particular for a plurality of buildings. These steps can be implemented, for example, by the control unit 110, 210 or 250, in particular by a microprocessor in the control unit, and can of course also be included in a computer programme.

For example, a computer-readable medium, in which this computer programme is represented, can be delivered to a computer or a microprocessor, the computer programme causing the microprocessor to implement the steps of the method. A computer programme product such as a CD or DVD can include this computer-readable medium.

In a first step 310, a signal transmitted by a central control unit with temperature setpoint value information is received by a control unit such as the control unit 110 in a building. In a second step 320, a temperature detection signal is received from at least one temperature sensor, such as the temperature sensor 125, which is representative of the temperature in a space.

As already described above, in a subsequent step 330 the control unit 110 can generate a control signal for one or more heating device controllers on the basis of the signal transmitted by the central control unit and the temperature detection signal. Then, in step 340, this control signal is transmitted to a heating device controller such as the heating device controller 120 in FIG. 1, in order to control at least one heating device such as the heating device 122.

The same method can also be used with central control of a lighting device. In a first step here a signal transmitted by a central control unit with light state setpoint value information is received by a control unit, such as the control unit 110, in a building. In a second step, a light state detection signal is received from at least one light sensor, such as the sensor 125, which is representative of the lighting conditions in a space.

Subsequently, on the basis of the signal transmitted by the central control unit and the light state detection signal the control unit 110 can generate a control signal for one or more lighting device controllers. This control signal is then transmitted to a lighting device controller, such as the operational state device controller 120 in FIG. 1, in order to control at least one lighting device such as the operational state device 122.

Similar to the temperature, the light in a building is also dependent upon the external conditions, and so here too constant lighting conditions in a space can be created, which in particular is not only beneficial for normal residential houses, but for business areas in which the presentation of goods is greatly dependent upon the lighting conditions. Moreover, most businesses have fixed opening times, and so a pre-specified lighting profile offers an advantageous energy saving potential.

A further example is the temperature in a refrigerator. When setting a specific cooling level of 1 to 7, for example, the cooling level is constant, but not the temperature of the refrigerator. Here the temperature at, for example, cooling level 5 can vary by a few degrees Celsius between summer and winter. Therefore, a central control system would also be advantageous here, and so depending on the environmental conditions the optimal temperature in the refrigerator is always obtained, and the freshness of the food stored in the latter can be guaranteed.

The system for central control can also be configured in order to measure noxious substances or gases. For example, natural gas escaping or a high concentration of CO2 can be measured with a sensor and then, if a pre-specified setpoint value is exceeded, opening of the windows or halting the supply of gas to the apartment is brought about.

Furthermore, humidity can likewise be measured, and then ventilation, if necessary, can be activated.

The system for central control can also be used for medical services, safety devices such as smoke alarm systems, or communications services, with a remotely located central control unit communicating with a control unit located in a building so that individual controllers in the building can be controlled according to the specifications of the central control unit and the sensor values measured.

From the description given above, the person skilled in the art will see that different modifications and variations of the system for the central control of operational devices and of the corresponding method can be implemented without straying from the scope of the invention.

Furthermore, the invention has been described with reference to specific examples which should, however, only serve to provide better understanding of the invention, and should not restrict the latter. The person skilled in the art also recognises immediately that many different combinations of hardware, software and firmware can be used in order to implement the present invention, in particular in order to realise the functions of the control unit.

1. A system for the central control of operational devices comprising
at least two operational device controllers for controlling at least two operational devices, each of the operational device controllers being designed to receive a control signal;
at least two sensors for detecting the operational state of the at least two operational devices, each of the sensors being designed to transmit an operational state detection signal;
at least one user-independent control unit in a building designed to receive an operational state detection signal and to transmit a control signal to at least one of the operational device controllers; and
a central control unit, which is communicatively connected to the at least one control unit for transmitting and receiving signals to and from the control unit, and which remotely controls the at least one user-independent control unit centrally, the central control unit being designed furthermore to transmit a receive signals to and from other control units,
the control unit generating the control signal on the basis of operational state setpoint value information in a signal from the central control unit.

2. The system according to claim 1, the operational state setpoint value information constituting at least one operational state setpoint value specified by the central unit for at least one operational device.

3. The system according to claim 1, further comprising
another control unit in another building which is communicatively connected to the central control unit in order to transmit and receive signals.

4. The system according to claim 3, the control unit being communicatively connected to at least one operational device controller and at least one sensor, and the other control unit being communicatively connected to at least one other operational device controller and at least one other sensor.

5. The system according to claim 1, the signal communication between the at least one control unit and the central control unit being implemented by means of mobile radio communication such as, for example, GSM or UMTS.

6. The system according to claim 1, the central control unit being designed to receive instructions for specifying and changing operational state setpoint value information via the internet or mobile radio from a terminal.

7. The system according to claim 1, the at least one control unit communicating wirelessly with the at least two operational device controllers and the at least two sensors.

8. The system according to claim 1, every operational device controller having identification so that a control signal with corresponding identification can be assigned to an operational device controller by the control unit.

9. The system according to claim 1, the control unit being designed to communicate with other devices.

10. A method for the central control of operational devices, in particular for a plurality of buildings, comprising the steps
receiving a signal transmitted by a central control unit lying in a remote location with operational state setpoint value information at a user-independent control unit in a building for remotely controlling the control unit centrally;
receiving an operational state detection signal from at least one sensor which is representative of the operational state in a space;
generating in the control unit a control signal on the basis of the signal transmitted by the central control unit and the operational state detection signal; and
transmitting the control signal to an operational device controller in order to control at least one operational device in the space.
